(19) United States
(12) Patent Application Publication
(10) Pub. No.: US 2018/0051763 A1
(43) Pub. Date: Feb. 22, 2018

(54) Spring For a Vehicle

(71) Applicant: Hendrickson Commercial Vehicle Systems Europe GmbH, Judenburg (AT)

(72) Inventors: Séverin Marteau-Lorant, Grand-Charmont (FR); Sébastien Brogly, Essert (FR)

(21) Appl. No.: 15/552,564

(22) PCT Filed: Dec. 28, 2015
(86) PCT No.: PCT/EP2015/081300

§ 371 Date: Aug. 22, 2017

(30) Foreign Application Priority Data
Feb. 23, 2015 (AT) A98/2015

(51) Int. Cl. F16F 1/02; F16F 1/18; F16F 1/368; B60G 11/02

(52) U.S. Cl. CPC F16F 1/027; F16F 1/185; B60G 2206/428; B60G 11/02; F16F 1/368

(57) ABSTRACT

A spring, in particular a flat spring (1), for use in connection with a vehicle, has a middle region (2), with the middle region (2) featuring a central axis (3), as well as two edge regions (4), with the edge regions (4) each having an end region (5). In an unladen state, at least one edge region (4) adjacent to the middle region (2) has a first curve region (6) with a first curve direction and a first vertex (7), with the first vertex (7) lying on one side of the central axis (3). Toward its end region (5), this edge region (4) has a second curve region (8) with a second curve direction and a second vertex (9), with the second curve direction opposed to the first curve direction and with the second vertex (9) lying on the opposite side of the central axis (3) to the first vertex (7).

The invention concerns a spring, in particular a flat spring, with the characteristics of the preamble of claim 1.

In automotive manufacturing, cushioning the wheels and the chassis of a vehicle with respect to one another is well established. Particularly for especially large and heavy vehicles, flat springs are used since a broad range of load requirements are covered by a simple construction form. In addition, flat springs can be serviced easily and easily restored in case of breakage.

Constructing flat springs in two parts, with a first part supporting lesser forces, for instance in unladen use or with a low load, and with a second part acting as support, for instance when the vehicle equipped with the flat spring bears heavy loads, is well established in the state of the art. Through this combination of two parts, a beneficial change in the spring characteristic curve is achieved. However, the transition when the second part of the spring becomes operative is abrupt, which negatively influences the driving quality of a vehicle which is equipped with such a two-part spring. The spring characteristic curve displays a knee which in particular negatively influences the driving quality of the vehicle.

In addition, such two-part flat springs have a much higher weight than one-piece designs, which negatively affects the energy consumption of a vehicle equipped with such a spring. Furthermore, the total weight of the vehicle rises, which leads to a reduction in the maximum permissible load.

To make the transition smoother, using multi-part flat springs rather than a two-part construction is well established in the state of the art. A truly progressive spring characteristic curve, on the one hand, is not thereby achieved. On the other hand, the known problems, which result from the high dead weight of the spring, are amplified.

A one-piece flat spring with progressive characteristics is known form DE 10 2013 107 889 A1. This spring is capable of cushioning the vertical force components which occur. It is, however, disadvantageous that horizontal force components can not be cushioned. This is particularly disadvantageous when the vehicle brakes, since the spring compresses during a braking process, with the horizontal force components occurring thereby increasing the risk of the spring breaking.

In order to be able to counteract the change in length of a spring under arising horizontal force components, in particular during braking, connecting the spring (usually the rear end of the spring in insertion position) to the chassis by means of a swiveling shackle positioned on the chassis is well established. The other end of the spring is usually immovably connected to the chassis. A shackle brings about the disadvantage that an additional part with an additional weight must be incorporated.

Therefore, the object of the invention is to overcome the disadvantages described above.

This object is solved according to the invention by means of a spring with the features of claim 1.

Preferred and advantageous embodiments of the spring according to the invention are the subject of the sub-claims.

The spring according to the invention is characterized in that, in an unladen state, at least one edge region bordering on the middle region displays a curve in a first curve direction and a first vertex (first curve region), with the first vertex lying on one side of the central axis, and in that this edge region displays a curve in a second curve direction and a second vertex (second curve region) toward its end region, in which the second curve direction is oriented opposite to the first curve direction and in which the second second vertex lies on the side of the central axis opposite to the first vertex.

Due to the described geometry of the spring, the following advantages arise:

A spring constructed according to the invention can have a strongly nonlinear, in particular progressive, spring characteristic curve, which has positive effects on the driving quality of a vehicle which is equipped with a spring according to the invention.

In addition, a spring according to the invention can not only cushion vertical force components, but horizontal force components as well, which occur in particular during the process of braking, since the first curve section effectively operates as a spring within the spring. Thus, the risk of the spring breaking is greatly reduced. Additionally, it is possible to do without shackles, since the spring itself counteracts the change in length that occurs otherwise. Since it can thus be prevented that the entire length, i.e. the distance between one longitudinal end to the other longitudinal end of the spring, changes at all, the spring can be positioned in a stationary manner, for instance above a rolled eye, on the chassis.

Furthermore, material and weight of the entire suspension can be conserved when using a one-piece construction of the flat spring, which both makes construction less expensive and reduces the total weight of the vehicle.

In the scope of the invention, it can be envisaged that the second curve region is positioned directly adjacent to the first curve region, with these regions merging into one another.

In an especially preferred embodiment of the invention, it is envisaged that it features a top side and a bottom side, with the top side pointing toward the chassis when installed in the vehicle, and that the spring of the first vertex is positioned on the side of the central axis on which the bottom side lies.

Additionally, it is preferred that the end region of the edge region is slanted away from the second vertex toward the side on which the middle region lies. Thus a functional reduction of the effective length of the spring under increasing load is supported.

In the scope of the invention, the edge regions can be shaped symmetrically or asymmetrically with regard to one another. The advantage of a symmetrically shaped spring is that an edge region can be implemented in a relatively flat manner, i.e. without or with an only slightly implemented first curve region, with less risk of the spring colliding with the chassis. Occurring horizontal force components can then be cushioned by the other edge region with the first curve region.

In the scope of the invention, the spring can include spring steel or composite material. The advantage of spring steel compared with composite material is a lower risk of the spring breaking.

In a preferred embodiment of the invention, it is envisaged that the edge region adjacent to the middle region is tilted toward the central axis at an angle (α) from the end of the middle region to the first vertex, with the angle (α) lying between 1° and 85°, preferably in the range from 10° to 60°, especially preferably in the range from 20° to 45°, in particular 25°.

In a further preferred embodiment of the invention, it is envisaged that a vertex axis, which is tilted toward the central axis at an angle (β), runs from the first vertex to the second vertex, with the angle (β) lying between 1° and 85°, preferably in the range from 10° to 70°, especially preferably in the range from 20° to 60°, in particular in the range from 45 to 55°.

In a further preferred embodiment of the invention, it is envisaged that at least one end region is tilted by an angle (γ) toward the central axis, with the angle (γ) lying between −90° and 90°, preferably in the range from −60° to 60°, especially preferably in the range from −10° to 45°, in particular 15°.

The use of a spring is recommended, with a force vector applied to the first curve region running essentially parallel to the central axis and a second force vector applied to the second curve region running essentially perpendicular to the central axis.

Additionally, a vehicle with a spring according to the invention is recommended.

Preferred and advantageous embodiments of the invention arise from the following description with reference to the included illustrations, in which preferred embodiments are shown.

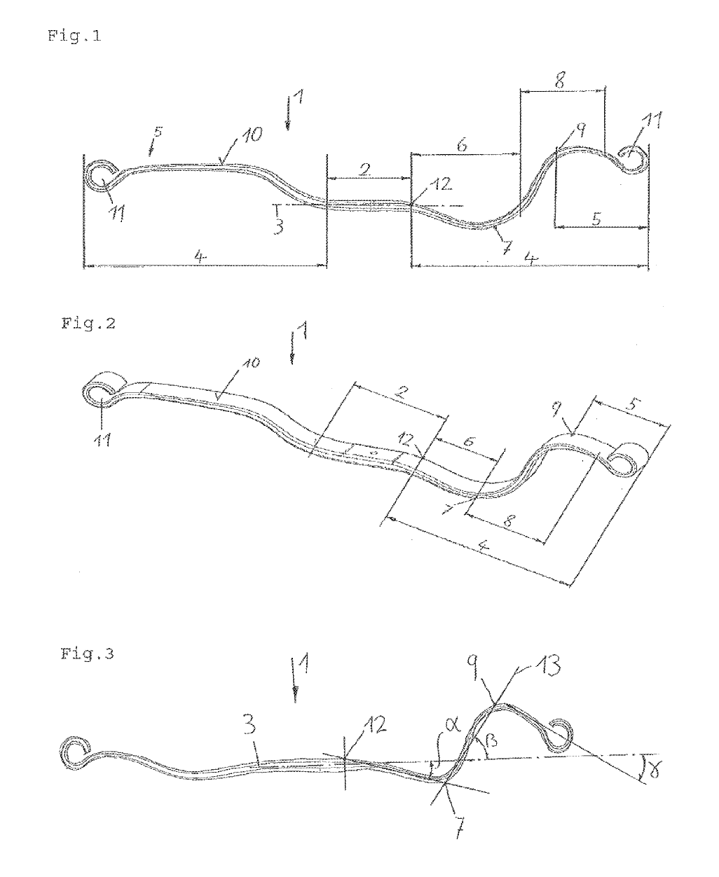

FIGS. 1 and 2 show an embodiment of a spring according to the invention,

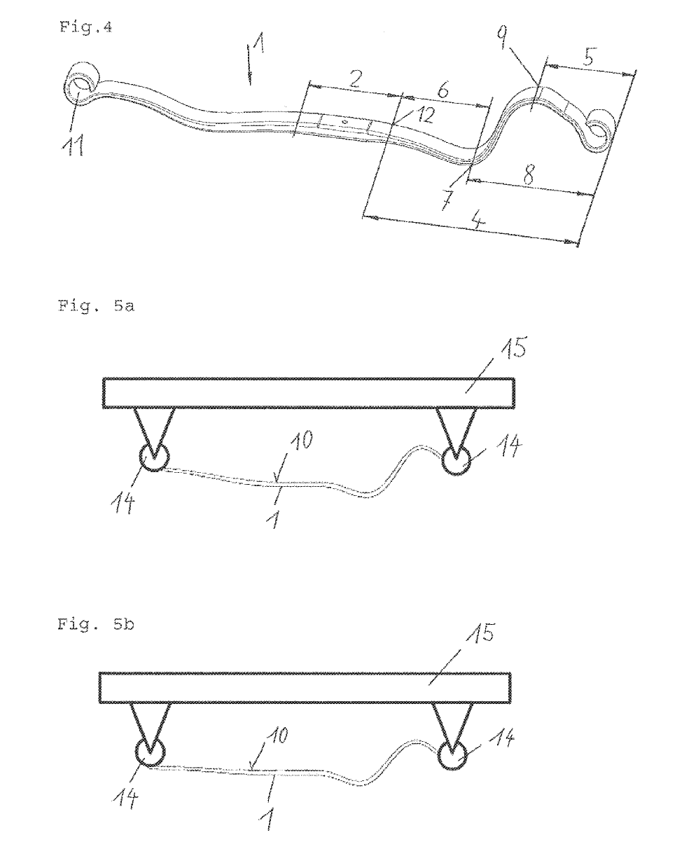

FIGS. 3 and 4 show a further embodiment of a spring according to the invention,

FIGS. 5a through 5c show a spring according to the invention in different load states, with the connection to a vehicle chassis is shown schematically,

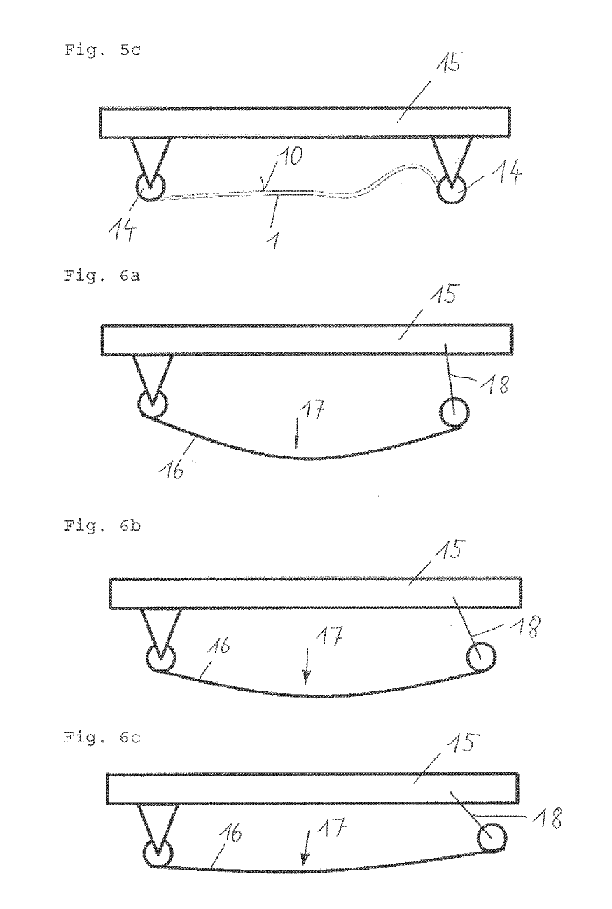

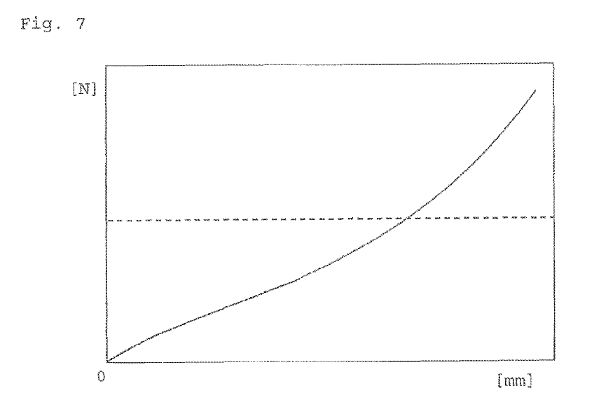

FIGS. 6a to 6c show a spring according to the state of the art, analogous to the load states shown in FIGS. 5a to 5c, with the connection to a vehicle chassis is shown schematically, and

FIG. 7 shows the spring characteristic curve of the spring according to FIGS. 5a to 5c.

In FIGS. 1 to 4, embodiments of a flat spring 1 according to the invention, made of spring steel, are depicted in an essentially load-free state. The flat spring 1 features a middle section 2 with a central axis 3 as well as two edge regions 4, respectively. The edge regions 4 each feature an end region 5. According to FIGS. 1 through 4, the right edge region 4 adjacent to middle region 2 features a first curve region 6 with a first curve direction and a first vertex 7, with the first vertex 7 lying on the bottom side of central axis 3. In the direction of its end region 5, this edge region 4 subsequently features a second curve region 8 with a second curve direction and a second vertex 9, with the second direction of curve opposed to the first direction of curve and with the second vertex 9 lying on the top side of the central axis 3. The end region 5 of the right edge region 4 is tilted from the second vertex 9 to the side on which the middle region 2 lies.

The top side of the flat spring 1 depicted in FIGS. 1 to 4 is its top side 10, which points toward the chassis in its assembled state in the vehicle.

The end regions 5 each feature a device 11 for connecting the spring 1 with the chassis of a vehicle, with these devices being rolled eyes in the depicted example embodiment. For the flat spring according to the invention other devices 11 can also be envisioned to connect the flat spring 1 with the chassis of a vehicle. Depending on the variety of flat spring 1 both devices 11 can be eyes. A device 11 can also be a rolled or formed, for instance inserted in end region 5, eye. Whereas the other end region 5 can run essentially flatly.

In the embodiment according to FIGS. 3 and 4, the edge region 4 adjacent to the middle region 2 is slanted from the end 12 of middle region 2 to the first vertex 7 by an angle (α) of c. 20° toward the central axis 3. From the first vertex 7 to the second vertex 9 runs a vertex axis 13, which is slanted at an angle (β) of c. 55° toward the central axis 3. The right end region 5 is slanted by an angle (γ) toward the central axis 3, on which the middle region 2 lies, with the angle (γ) being c. 25°.

FIGS. 5a to 5c show how a flat spring 1 is deformed under an increasing load, beginning with FIG. 5a up to FIG. 5c. FIG. 5a essentially corresponds to to an unladen state. FIG. 5b corresponds to a state of normal load, in which the vehicle is stationary. FIG. 5c corresponds to a state of heavy load, in which the vehicle is moving.

In FIG. 5A the effective length of flat spring 1 essentially equals the entire length of the flat spring 1, since the flat spring 1 cushions appreciably over its entire length. As the load increases, the right edge region 4 tilts, in particular its end region 5, more strongly toward the middle region 2, i.e. the edge region 4 tilts more strongly toward the central axis 3. The bending moment in the edge region decreases through the vertical force vector applied there at a smaller angle with regard to the longitudinal direction of the end region, so that edge region 4 cushions less. Thus, the effective length of flat spring 1 is reduced. The reduction of the effective length of flat spring 1 in connection with the rising load leads to a progressive spring characteristic curve, such as are depicted as an example in FIG. 7. The spring rate, therefore, increases continually with rising load and dependent on this load.

The effective length of the flat spring 1 may be reduced between FIGS. 5a and 5c, yet the total length of flat spring 1, i.e. the distance between the first end to the second end of flat spring 1, remains essentially unchanged through the first curve region 6. Consequently, flat spring 1 can be connected at both longitudinal ends with a chassis 15 in a stationary manner by means of a spring support 14.

Between FIGS. 5a and 5c, the position of the middle region 2 changes in such a manner that it approaches chassis 15 under rising load. The shape of flat spring 1 changes in such a manner that the first curve region 6 runs in an increasingly flat manner, with the angle (γ) becoming increasingly smaller, with the angle (β) also becoming increasingly smaller.

FIGS. 6a to 6c show a flat spring 16 according to the state of the art, analogous to the load states depicted in FIGS. 5a to 5c, in which a connection to a chassis 15 is also depicted schematically. As can be seen, the middle section 17 of the flat spring 16 approaches the chassis 15 under rising load. The total length of the flat spring 16 thereby changes with an increasing load, with the distance from the first end to the second end of the flat spring 16 increasing with a rising load. Thus, the flat spring 16 can not be connected in a stationary manner at both longitudinal ends with a chassis 15 via a spring support 15. In FIGS. 6a to 6c, only the left end of the flat spring 16 is connected in a stationary manner to the chassis 15 via a spring support. The right end of the flat spring 16 (usually the rear end in insertion position) is connected with a shackle 17, which is swivel-mounted on the chassis.

In FIG. 7, a progressive spring characteristic curve of the flat spring 1 according to FIGS. 5a through 5c is depicted. These spring characteristic curve display no bend, which negatively affects the driving quality of the vehicle, in particular. The course of the spring characteristic curve up to point 17 can essentially be associated with a load state corresponding to FIG. 5b. The course of the spring characteristic curve beginning with point 17 can essentially be associated with a load state corresponding to FIG. 5c.

In sum, a sample embodiment of the invention can be described as follows:

A spring, in particular a flat spring, for use in connection with a vehicle, has a middle region, with the middle region having a central axis, as well as two edge regions, with the edge regions each having an end region. In an unladen state, at least one edge region adjacent to the middle region has a first curve region with a first curve direction and a first vertex, with the first vertex lying on one side of the central axis. Toward its end region, this edge region has a second curve region with a second curve direction and a second vertex, with the second curve direction opposed to the first curve direction and with the second vertex lying on the opposite side of the central axis to the first vertex.

1. A spring, in particular a flat spring, for use in connection with a vehicle, with a middle region, with the middle region having a central axis, as well as two edge regions, with the edge regions each having an end region, characterized in that, in an unladen state, at least one edge region adjacent to the middle region has a first curve region with a first curve direction and a first vertex, with the first vertex lying on one side of the central axis, and in that, toward its end region, this edge region having a second curve region with a second curve direction and a second vertex, with the second curve direction opposed to the first curve direction and with the second vertex lying on the opposite side of the central axis to the first vertex.

2. A spring according to claim 1, characterized in that the second curve region is positioned adjacent to the first curve region.

3. A spring according to claim 1 or 2, characterized in that is features a top side and a bottom side, with the top side points toward the chassis in an assembled state, and in that the first vertex is positioned on the side of the central axis on which the bottom side lies.

4. A spring according to claim 1, characterized in that the end region of the edge region is slanted from the second vertex toward the side, on which the middle section lies.

5. Spring according to claim 1, characterized in that the edge regions are shaped symmetrically or asymmetrically with regard to one another.

6. A spring according to claim 1, characterized in that it contains spring steel and/or composite material.

7. A spring according to claim 1, characterized in that the edge region adjacent to the middle region is tilted by an angle from the end of the middle region to the first vertex toward the central axis, with the angle (α) lying between 1° and 85°, preferably in the range from 10° to 60°, especially preferably in the range from 20° to 45°, in particular 25°.

8. A spring according to claim 1, characterized in that a vertex axis, which is tilted toward the central axis at an angle (β) runs from the first vertex to the second vertex, with the angle (β) lying between 1° and 85°, preferably in the range from 10° to 70°, especially preferably in the range from 20° to 60°, in particular in the range from 45 to 55°.

9. A spring according to claim 1, characterized in that at least one end region is tilted by an angle (γ) toward the central axis, with the angle (γ) lying between −90° and 90°, preferably in the range from −60° to 60°, especially preferably in the range from −10° to 45°, in particular 15°.

10. A method of use of a spring according to claims 1 to 9, characterized in that a force vector applied to the first curve region essentially runs parallel to the central axis and a force vector applied to the second curve region essentially runs perpendicular to the central axis.

11. A vehicle characterized by at least one spring according to claim 1.
